(19) United States
(12) Patent Application Publication
(10) Pub. No.: US 2012/0240686 A1
(43) Pub. Date: Sep. 27, 2012

(54) PRESSURE MEASURING PORT WITH THERMOPLASTIC ELASTOMERIC INTERFACE

(76) Inventors: MAX D. BLOMBERG, Ventura, CA (US); CHRISTIAN R. JULIEN, Simi Valley, CA (US)

(21) Appl. No.: 13/429,164

(22) Filed: Mar. 23, 2012

Related U.S. Application Data
(60) Provisional application No. 61/467,541, filed on Mar. 25, 2011.

(51) Int. Cl. G01L 7/00

(52) U.S. Cl. 73/756

(57) ABSTRACT

A pressure monitoring system and method for aseptically measuring the pressure of a fluid. A port communicates with a fluid cavity. A flexible barrier, which may be made from a thermoplastic elastomeric material, is integrally bonded to the port, sealing the port. A pressure gauge is coupled to the port over the barrier. Pressure of the fluid within the fluid cavity is measured by the pressure gauge via the barrier.

### CROSS-REFERENCE TO RELATED APPLICATION

This application is based upon and claims priority on U.S. Provisional Application No. 61/467,541, filed on Mar. 25, 2011, the contents of which are fully incorporated herein by reference.

### FIELD OF THE INVENTION

The invention relates to devices for measuring fluid pressure, and more particularly to a thermoplastic elastomeric gauge interface for pressure measurements of a single-use fluid assembly.

### BACKGROUND

Measuring the pressure of a fluid in a closed or sealed fluid container or fluid flow path can provide very useful information about the fluid or a process involving the fluid. For example, in the pharmaceutical industry, various types of fluids are used in the manufacture, preparation, and testing of pharmaceutical compositions, including drugs, drug components, and intermediates, along with cleaning and other process solutions and fluids. These fluids may be filled into a container, transported, filtered, pumped, and stored, and at each step it may be beneficial to monitor or measure the pressure of the fluid inside a container, upstream and downstream of a filter, upstream and downstream of a pump, and/or at other points in the fluid path. However, it is also important to maintain sterility of the fluid at all times before, during, and after the pressure measurement. Due to constraints in aseptic processing and cross-contamination concerns, sterile flexible and rigid fluid containers are often used a single time and discarded. Therefore, a system is needed to aseptically and repeatedly measure the pressure of a fluid in a single-use, sealed fluid path.

Single-use pressure gauges have been used within a permanently sealed and sterilized fluid path, in order to provide a measurement from within the path without exposing the path to the outside environment. Single-use pressure gauges assembled within the flow path and sterilized as one integral and fully enclosed unit preserve the sterility of the flow path, but these gauges are expensive and difficult to calibrate post-sterilization.

Re-usable pressure gauges mounted outside a sterilized flow path may be used where the flow path is provided with a pressure port. A flexible membrane may be clamped between the port and the pressure gauge to serve as a sterility barrier while at the same time enabling the gauge to sense the pressure of the fluid across the flexible membrane. However, this mechanical arrangement risks exposure of the fluid path to the outside environment through the interface of the port, the membrane, and the pressure gauge, thereby compromising sterility. A leak or misalignment or even a simple miss-step by the operator during assembly can expose the fluid path and compromise sterility of the entire system.

Thus, there remains a need for a system that enables accurate and repeatable pressure measurements by a re-usable pressure gauge without compromising the sterility of a disposable fluid path.

### SUMMARY

The invention relates to devices for measuring fluid pressure, and more particularly in an exemplary embodiment to a thermoplastic elastomeric gauge interface for pressure measurements of a sterile disposable fluid assembly. In one embodiment, a pressure measuring port includes a flexible barrier that creates a seal between the sterile fluid path and the outside environment. A re-usable pressure gauge is attached opposite this barrier, to sense the flexing of the barrier and thereby accurately measure the pressure of the fluid. The flexible barrier is permanently attached to a housing or body that contains the sterile fluid path, such as by welding the barrier to the housing. In one embodiment, the barrier is a thermoplastic elastomeric film that is welded to the housing to integrally attach the barrier to the housing and seal the fluid cavity inside. The non-removable, welded bond between the barrier and the housing is an integral bond and protects the sterile fluid path and prevents inadvertent exposure to the outside environment. The pressure gauge attached on the opposite side of the barrier can be re-used and need not be sterilized, as it does not contact the fluid. This system provides a flexible membrane for accurate pressure measurements with a re-usable pressure gauge, while also preserving the sterility of the disposable fluid path or space. The system enables a re-usable pressure gauge to be used for repeated pressure measurements with a sterile disposable, permanently-sealed fluid handling assembly.

In one embodiment, a sterilizable pressure monitoring system for aseptic fluid pressure measurements includes a fluid cavity and a pressure measuring port. The pressure measuring port includes a port communicating with the fluid cavity, and a flexible barrier sealing the port. The barrier is integrally bonded to the port. The system also includes a pressure gauge interfacing with the barrier to sense a pressure in the fluid cavity. The pressure measuring port can be integrated into a fluid path, a fluid container, or a fluid filter.

In one embodiment, a sterilizable pressure measuring port for aseptic fluid pressure measurements includes a housing having an internal cavity for transport of a fluid, a port communicating with the internal cavity of the housing, and a thermoplastic elastomeric film welded to the port to seal the port. The internal cavity is sealed by the film to prevent direct contact with an external pressure gauge, allowing aseptic operation of the assembly.

In one embodiment, a method for aseptically measuring the pressure of a fluid includes providing a housing having a port communicating with a fluid cavity, welding a barrier to the port to seal the fluid cavity, sterilizing the housing, the barrier, and the fluid cavity, and attaching a pressure gauge to the barrier outside the sealed fluid cavity.

In an exemplary embodiment a pressure monitoring system for aseptic fluid pressure measurement is provided. The system includes a port and a flexible barrier integrally bonded to the port, sealing the port, and a pressure gauge coupled to the port over the barrier. In another exemplary embodiment, the pressure measuring port is coupled to a fluid path, a fluid container, or a fluid filter. In one exemplary embodiment, the pressure gauge is coupled to the port by a clamp that clamps the pressure gauge to the port. In a further exemplary embodiment, the barrier is made of a thermoplastic elastomeric material. In yet further exemplary embodiment, the barrier is welded to the port. In another exemplary embodiment, the port is made of polypropylene. In one exemplary embodiment, the port includes an annular flange and a top surface. The flange has a thickness within the range of about 0.04 inches to about 0.075 inches, and the top surface includes a flat welding area on to which is integrally bonded to the barrier by welding. In another exemplary embodiment, the fluid cavity includes a filter.

In a further exemplary embodiment, a pressure measuring port for aseptic fluid pressure measurement is provided. The pressure measuring port, a housing including an internal cavity for transport of a fluid, a mouth defining an opening communicating with the internal cavity of the housing; and a thermoplastic elastomeric film welded to the mouth to seal the mouth, wherein the internal cavity is aseptically sealed by the film from contact with an external pressure gauge. In yet a further exemplary embodiment, the housing is made of polypropylene. In another exemplary embodiment, the housing houses a filter.

In another exemplary embodiment, a method for aseptically measuring a pressure of a fluid is provided. The method includes providing a housing having a port communicating with, a fluid cavity, integrally bonding a barrier to the port to seal the fluid cavity, coupling a pressure gauge to the sealed port outside the sealed fluid cavity, and measuring a pressure of the fluid in the sealed fluid cavity using the pressure gage via the barrier. In one exemplary embodiment, integrally bonding the barrier to the port includes welding the barrier to the port. In another exemplary embodiment, the method also includes sterilizing the housing, the barrier, and the fluid cavity prior to measuring. In yet another exemplary embodiment, the method further includes discarding the housing and the barrier and re-using the pressure gauge to aseptically measure a pressure of a fluid in another fluid cavity. In a further exemplary embodiment, the port is made of polypropylene and the barrier is made of a thermoplastic elastomeric material. In yet a further exemplary embodiment, the housing houses a filter. In another exemplary embodiment, the pressure gauge is re-usable for aseptically measuring a pressure of a fluid in another fluid cavity or for aseptically measuring a pressure of another fluid. In a further exemplary embodiment, the pressure gauge is re-useable for aseptically measuring the pressure of a fluid.

### BRIEF DESCRIPTION OF THE DRAWINGS

FIGS. 1A-D show a barrier welded to a port body to create a pressure measuring port according to an embodiment of the invention.

FIG. 2 is a cross-sectional view of a pressure measuring port according to an embodiment of the invention.

FIG. 3 is an exploded view of a pressure monitoring system according to an embodiment of the invention, including a pressure gauge, clamp, and pressure measuring port, integrated into a fluid path assembly.

FIG. 4 is an exploded view of a pressure monitoring system according to an embodiment of the invention, including a pressure gauge, clamp, and pressure measuring port, integrated into a fluid container.

FIG. 5 is an exploded view of a pressure monitoring system according to an embodiment of the invention, including a pressure gauge, clamp, and pressure measuring port, integrated into a fluid filter.

### DETAILED DESCRIPTION

The invention relates to sterilizable devices for measuring fluid pressure, and more particularly to a thermoplastic elastomeric gauge interface for pressure measurements of a disposable fluid path assembly. In one embodiment, a pressure measuring port includes a flexible barrier that creates a seal between the sterile fluid path and the outside environment. A pressure gauge, which may be re-useable, is attached opposite this barrier, to sense the flexing of the barrier and thereby accurately and repeatedly measure the pressure of the fluid. The flexible barrier is permanently attached to a housing or body that contains the sterile fluid path, such as by welding the barrier to the housing. In one embodiment, the barrier is a thermoplastic elastomeric film that is welded to the housing to integrally attach the barrier to the housing and seal the fluid cavity. The non-removable, welded bond between the barrier and the housing protects the sterile fluid path and prevents inadvertent exposure to the outside environment. The pressure gauge attached on the opposite side of the barrier can be re-used and need not be sterilized, as it does not contact the fluid. This system provides a flexible membrane for accurate pressure measurements with a re-usable pressure gauge, while also preserving the sterility of the disposable fluid path. The system enables a re-usable pressure gauge to be used with a disposable, permanently-sealed fluid assembly. In other exemplary embodiments, the gauges used may not be re-useable.

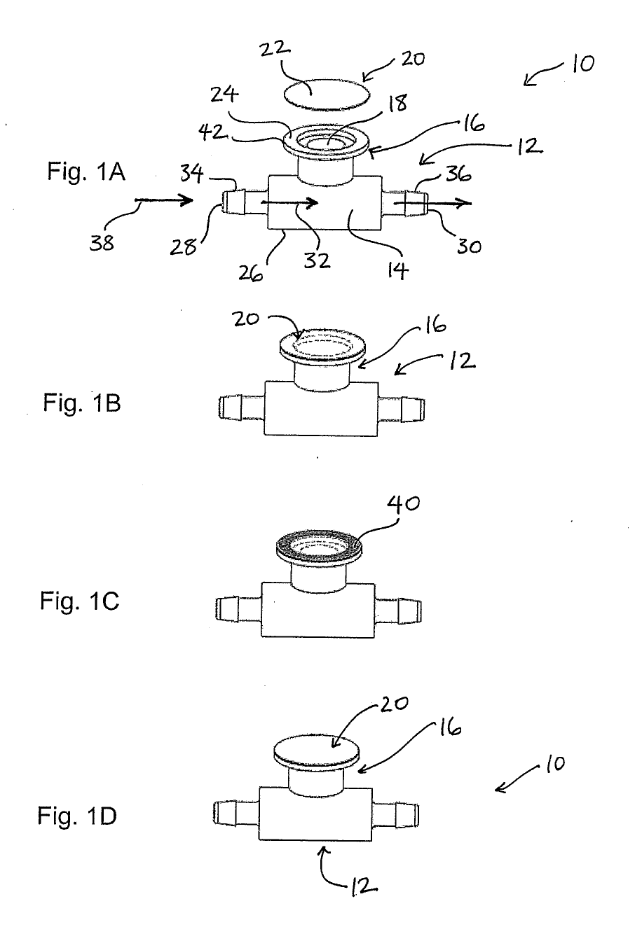

A pressure measuring port 10 according to one embodiment of the invention is shown in FIGS. 1A-1D. The assembly 10 includes a housing or body 12 that contains a sterile fluid cavity or fluid path 14 inside the housing. In order to enable pressure measurements of this fluid, the housing 12 also includes a port 16 that extends from the housing. The port 16 (i.e., is in fluid communication with) includes an opening 18 at its upper end, opposite the housing. The port 16 interconnects to the fluid cavity 14. This opening is sealed by a barrier 20. The barrier 20 is a flexible membrane or diaphragm that responds to pressure inside the fluid cavity 14 by flexing inwardly or outwardly. This movement can be detected by a pressure gauge (as discussed below). In the embodiment of FIGS. 1A-D, the barrier 20 is a thin sheet of thermoplastic elastomeric (TPE) film 22, in the shape of a circle or disc.

The barrier 20 is dimensioned to overlap a top surface 24 of the port 16, to cover the port and the opening 18, sealing the fluid cavity 14 from the outside environment. This fluid cavity 14 may be a closed system, a container, or a fluid path between other components of a disposable fluid system. In FIG. 1A, the housing 12 is a T-connector or T-fitting 26, which includes an inlet 28 at one end, an outlet 30 at the opposite end, and the port 16 between the inlet and outlet. Fluid 32 may enter the inlet, pass through the sterile fluid cavity 14, and exit through the outlet 30. The barrier 20 seals this space by closing the interconnected opening 18 of the port 16. The inlet 28 and outlet 30 may be connected to tubing, hoses, or other components of the sterile fluid path 38. For example, in FIG. 1A, the inlet and outlet each include a hose barb 34, 36, respectively, for attachment to a hose or tube that fits around the hose barb. In other embodiments, the inlet and outlet may include threaded connections, tri-clamp, snap-fit connections, or other types of connections.

FIG. 1A shows the housing 12 and barrier 20 in an exploded view, before the barrier 20 has been attached to the housing 12. In FIG. 1B, the barrier 20 overlaps the top surface 24 of the housing 12, where the barrier is to be attached. In FIG. 1C, the overlapping area 40 is highlighted, identifying the surface area where the barrier 20 and port 16 contact each other. In one embodiment, the barrier 20 and port 16 are welded together at this overlapping area 40. When the two components are welded together, using well known methods, the area 40 identifies the bonded area or welded area between the two components. FIG. 1D shows the result with the two components welded together, forming one unified piece. A pressure gauge attached above the barrier 20 can measure the pressure inside the sealed fluid cavity 14.

In the pharmaceutical industry, the housing or body 12 is often an industry-standard component, such as the T-connector 26, or fittings or connectors with other shapes and sizes. These fittings are commonly used to connect tubes, filters, clamps, pumps, and other components in a fluid path. The housing 12 is often manufactured from a polyolefin, such as a polypropylene, a polyethylene, or a fluoropolymer such as a polyvinylidene fluoride or a polyvinylidene fluoride copolymer of hexafluoropropylene. These plastic polymer materials are chosen because they are chemically compatible with a variety of solutions, are biocompatible, and are cost effective, enabling the housing 12 to be discarded rather than cleaned and re-used. Also, the plastic polymer materials are capable of withstanding gamma radiation for sterilization (“gamma-stable”), and they are rigid and lightweight.

However, a polypropylene or other plastic polymer material of the housing 12 cannot be bonded to silicone by welding. Silicone has previously been used as the material for the flexible membrane above the port. Silicone has been chosen for this membrane because it is flexible and gamma-stable. It accurately transmits pressure from the fluid to an external pressure gauge. Thus, the housing and the membrane are each manufactured according to certain desirable material characteristics, but the result is two materials that are incompatible with each other, meaning they cannot be permanently sealed to each other. To overcome this difficulty, adhesives have been used to attach the silicone membrane to the housing, and mechanical components such as clamps and carefully dimensioned grooves are used to mechanically hold the silicone membrane in place above the port.

As mentioned above, such an arrangement has a high propensity to compromise the sterility of the fluid cavity below the membrane and risks exposure to the outside environment or to the adhesive between the membrane and the housing. However, due to the desirable elastomeric characteristics of silicone for the membrane and polymers used for the housing, these risks have been tolerated and tedious procedural steps implemented to minimize the risk of exposure.

In an embodiment of the invention, the barrier 20 is manufactured from thermoplastic elastomer (TPE). The TPE material is flexible, enabling the barrier to transmit pressure to a pressure gauge, and certain TPE formulations are compatible with polyolefin, enabling the barrier to be directly bonded to the housing 12. TPE's are a group of polymeric materials with both thermoplastic and elastomeric properties. TPE subclasses include styrenic copolymers, polyolefin blends, elastomeric alloys, thermoplastic polyurethanes, thermoplastic copolyesteres and thermoplastic polyamides. TPE's of particular interest are flexible thermoplastic polyolefin elastomers (POE's) derived from blends or mixtures of a semi crystalline polyolefin and an amorphous elastomer, collectively referred as TPO's, alongside thermoplastic vulcanizates (TPVs) which are mechanically compounded mixtures of polyolefin (such as for example polypropylene or polyethylene) and an elastomer (such as for example, Ethylene Propylene Diene Monomer (EPDM) or more generally Ethylene Propylene (EPR)) that is vulcanized during processing. In one embodiment, the TPE material includes a styrene ethylene butylene styrene (SEBS) compound containing a polyolefin, and thus this TPE material is compatible with polyolefin. When the barrier 20 is made from a SEBS-based TPE containing polyolefin, it is both flexible and heat-weldable to a housing made out of a polyolefin such as a polypropylene. The result is a pressure measuring port that is permanently sealed, and that interfaces with an external, re-usable pressure gauge. The elastomeric properties of the SEBS-based TPE containing polyolefin enable it to transmit pressure to the external pressure gauge without absorbing the pressure, so that measurements are accurate and repeatable. The polymer properties of the SEBS-based TPE containing polyolefin enable it to be welded to a polyolefin housing.

In one embodiment, the TPE material has a low durometer and can be extruded as film. In another embodiment the TPE material can be injection molded. In one embodiment, the TPE film has a thickness in the range of approximately 0.005 inches to 0.04 inches. The thickness may vary based on the durometer of the TPE material. A TPE material with a low durometer allows for pressure measurements with good resolution. In an exemplary embodiment, a TPE film is provided with a durometer value in the range of approximately 50-70 A (shore A hardness). In one embodiment, the TPE film is capable of transmitting pressures in the range of less than 20 psid.

In one embodiment, the TPE material is pharmaceutical-grade (indicating that its constituents can be traced through manufacture), bio-compatible (indicating that the extracts or emissions by the material are not harmful to living cells), and non-pyrogenic.

In one embodiment, the TPE material contains polypropylene in its formulation, enabling it to thermally bond with the housing 12, such as the port 16. The TPE subclasses that contain polypropylene in their polymeric formulation represent suitable materials in the manufacture of a port barrier. These TPE materials are directly heat weldable to materials that are used to manufacture the body of the port, such as polypropylene, polyethylene, and polyvinylidene fluoride copolymer of hexafluoropropylene.

Example TPE materials are commercially available from a variety of manufacturers such as Versaflex TPE alloys (GLS Thermoplastic Elastomers, McHenry, Ill.); Kraton® polymers (GLS Thermoplastic Elastomers, McHenry, Ill.); Thermolast® M Series elastomers (Kraiburg TPE GmbH & Co. KG, Germany), Medalist® Versatile Series elastomers (Teknor Apex Company, Pawtucket, R.I.); Cellene® (Colorite Polymers, Ridgefield, N.J.); Mediprene® thermoplastic elastomers (Elasto, [symbol] m [symbol] l, Sweden), Evoprene™ (AlphaGary, Leominster, Mass.), Santoprene (Exxon Mobile, Houston, Tex.), and Formolene (Formosa Plastics Corporation, Livingston, N.J.).

In one embodiment, the TPE material is extruded into a thin film and cut into a disc sized to overlap the port 16, such as TPE film 22 shown in FIG. 1A. This TPE disc is then thermally welded to the port. The welding process creates a bonded area 40 between the barrier 20 and the port 16. The bonded area 40 is a direct bond between the two materials, meaning that it does not rely on adhesives or mechanical connections (such as clamps, threads, snap-fits, rings, etc.). The barrier 20 is directly bonded to the port 16, creating a single unified piece. The sealed pressure measuring port 10 shown in FIG. 1D is a single unitary component including the rigid plastic housing 12 with integral elastic seal 20.

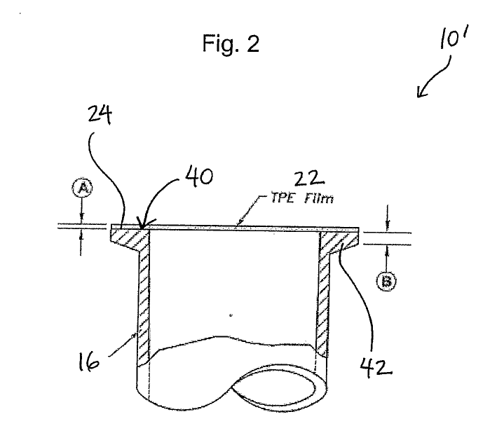

A partial cross-sectional view of a pressure measuring port 10′ including a port 16 and TPE film 22 is shown in FIG. 2. In this embodiment, the port 16 includes an annular flange 42, which creates the annular top surface 24. The TPE film 22 overlaps the top surface 24 and is sized to match the outer dimensions of the top surface. The top surface 24 of the flange 42 is flat and smooth, to maximize the surface area for welding. The TPE film 22 is heat-welded to the port to create the bonded area 40. The TPE film 22 covers the port 16 and closes the top opening of the port, to seal the fluid cavity inside. The thickness of the TPE film is indicated by letter A. In one embodiment, the TPE film has a thickness in the range of approximately 0.005 inches to 0.04 inches.

The thickness of the flange 42 at its outermost edge is indicated by the letter B. The flange widens in dimension B as it approaches the port 16. It should be noted that the thickness B in an exemplary embodiment is larger than the thickness of standard ports used with silicone barriers. The additional thickness B is provided to compensate for the thinner TPE film 22. The TPE film is thinner than most silicone membrane barriers, which include a standard sanitary gasket as part of their interface, and therefore the flange 42 is made thicker so that the same industry-standard clamps will fit the assembly 10′ with the combined thickness A+B. The combined thickness of A+B is determined according to the established industry standards for the specific gauge interface, so that the thickness is equal to the thickness of a standard flange and silicone gasket. In one embodiment, the combined thickness of A+B is approximately 0.19 inches, and the thickness of the flange 42 at B is within the range of about 0.17 inches to about 0.185 inches.

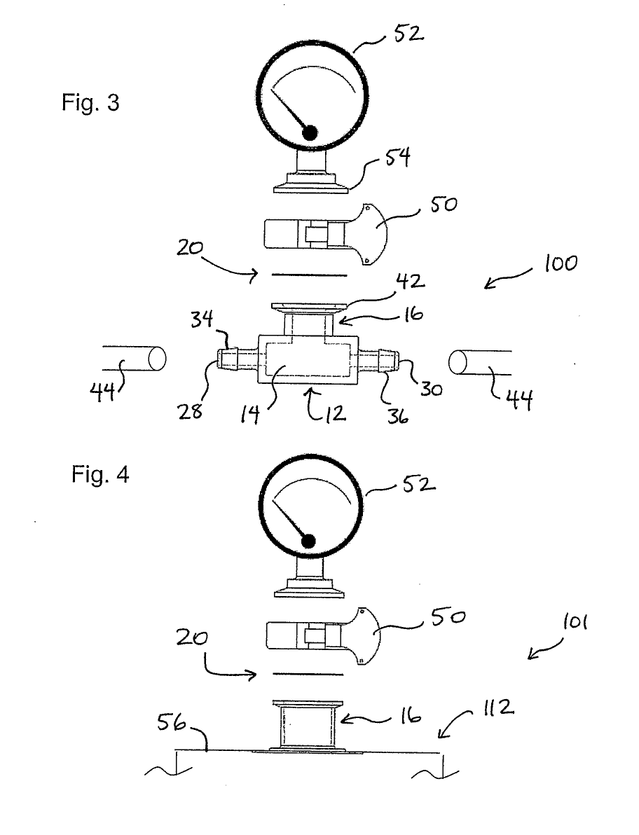

The TPE barrier 20 can be used in various aseptic fluid applications, three of which are shown as examples in FIGS. 3-5. In FIG. 3, a pressure measuring port 100 includes a T-connector housing 12 with an inlet 28, outlet 30, port 16, and TPE barrier 20. The TPE barrier 20 is welded to the top surface of the port 16. The T-connector housing 12 is connected to two hoses or tubes 44, one tube attached to each hose barb 34, 36. The tubes 44 connect to other components of the fluid system, such as filters, pumps, containers, etc. The pressure monitoring system also includes a clamp 50 and an external, re-usable pressure gauge 52. In one embodiment the pressure gauge 52 is a sanitary stainless steel digital or analog pressure gauge or pressure transducer with a connecting mechanism such as a lower flange 54. The clamp 50 may be a tri-clamp or other standard clamp used in the industry. The clamp 50 clamps the flange 42 of the port to the flange 54 of the pressure gauge, to attach the pressure gauge to the fluid system. The pressure gauge 52 interfaces with the barrier 20 to measure the pressure of the fluid in the sterile fluid cavity 14 inside the housing 12. The pressure measuring port 100 can be integrated at any location in a fluid system, wherever a pressure measurement is desired. For example, a pressure measuring port 100 can be provided upstream and another pressure measuring port 100 downstream of a container, pump, or filter, or between pumps or other components, to measure a pressure drop or increase.

FIG. 4 shows a pressure measuring port 101 according to another embodiment of the invention. In this embodiment, the pressure measuring port 101 is integrated into a fluid container 56, and the housing 112 takes the shape of the container itself. The port 16 is built into the container 56. The port 16 extends upwardly from the top wall of the container 56, to enable a pressure measurement of the fluid stored inside the container 56. The container 56 may be a flexible or rigid bio-container, pressure vessel, or other types of fluid containers. As before, the port 16 may be sealed closed by a TPE barrier 20, and a pressure gauge 52 may be attached by a clamp 50.

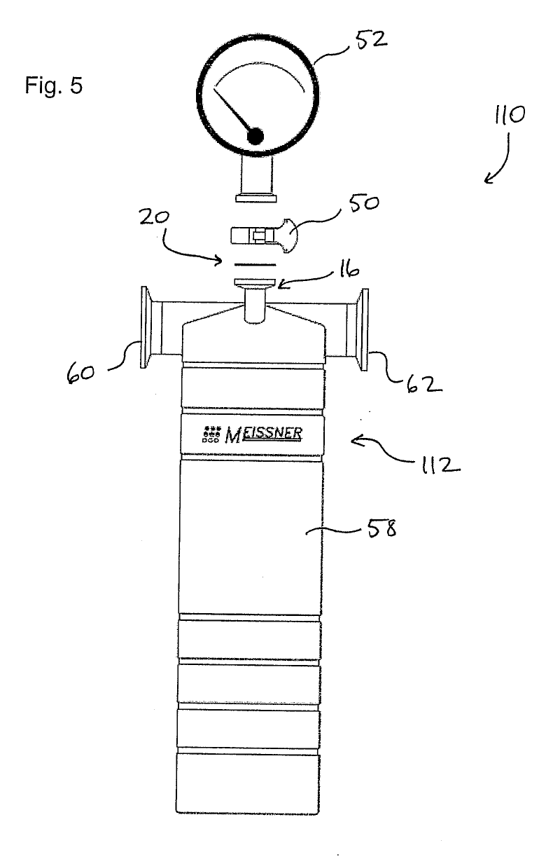

FIG. 5 shows a pressure measuring port 110 according to another embodiment of the invention. In this embodiment, the housing 112 is a filter 58 with a filter inlet 60 and filter outlet 62. The pressure measuring port 110 includes a built-in port 16 at the top of the filter, sealed by a TPE barrier 20. Fluid enters the filter at the inlet 60, passes by the port 16, passes through filter membranes within the filter, and then exits through the outlet 62. The gauge 52 attached to the port 16 can be used to measure the pressure of the fluid before it has passed through the filter membranes, to identify a pressure drop across the filter.

In an embodiment, the barrier or seal 20 includes a TPE film 22 that is integrally bonded to the port 16 by a welding process. In particular, the welding process joins the two materials—the TPE film 22 and the port 16—by melting and coalescing the two materials together. The TPE film 22 and the top surface 24 of the port 16 are exposed to heat and pressure, causing the material at the interface of the two components to melt and liquefy. In one embodiment, the portion of the TPE film above the bond area 40 melts, from the top surface of the TPE film through the bottom surface of the TPE film. A portion of the material of the body 12 also melts, at the bond area 40. The melted portions of the TPE film and the port body 12 (at the area 40) flow together and coalesce, and the coalesced portion is then cooled to solidify. Pressure is applied during cooling to encourage the bonding of the two materials. The result is an integral bond directly between the barrier 20 and the port 16, forming one continuous piece, as distinguished from a bond created by an adhesive or glue or other separate material or component between the barrier and the port. The lower surface of the TPE film 22 and the top surface 24 of the port 16 melt together and solidify to form an integral joint. This welding process integrally bonds the TPE film 22 to the port 16. Conventional thermal impulse sealers as known in the art can be used for the welding process.

In one embodiment, a TPE film comprising polypropylene is welded to a port comprising polypropylene, and the polypropylene constituents of the two components are bonded together by the welding process.

In one embodiment of the invention, a method is provided for integrally bonding a pressure conveying membrane to a housing to seal a fluid cavity. The method includes providing a housing that includes a fluid cavity and a port communicating with the fluid cavity, and then welding a barrier to the port to seal the fluid cavity, creating a unified pressure measuring port. In one embodiment, the barrier is thermally welded to the port. In one embodiment, the thermal welding includes heating the barrier and the top surface of the port to about 350° F. for about 15 seconds, and cooling the barrier and port under a pressure of about 30 psi. After welding, the method includes sterilizing the housing, the barrier, and the fluid cavity, such as by gamma radiation. After sterilization, the sealed pressuring measuring port can be used in a fluid system, and an external pressure gauge can be attached to the barrier outside the sealed fluid cavity. After use, the pressure measuring port (including the housing and barrier) is disposed of, and the pressure gauge can be re-used. In this method, the pressure gauge does not need to be sterilized, as it never contacts the fluid in the fluid path. The pressure gauge can be calibrated at any time.

Thermally welding the TPE barrier to the housing creates an integral elastomeric seal. This integral seal enables pressure measurements across the flexible TPE barrier, while permanently sealing the sterile fluid path. The pressure gauge can be attached, detached, and re-used repeatedly without exposing the fluid path to the ambient environment. The TPE seal maintains a closed fluid path.

This method creates a permanent seal while still providing access to the fluid for external pressure measurement. The seal is permanently bonded to the housing, but remains flexible. In addition to being flexible and weldable, the TPE barrier is gamma-stable and bio-compatible. Furthermore, the TPE barrier satisfies pharmaceutical industry standards, matches existing dimensions, and can be used with the same clamps, hoses, gauges, and other equipment used in the industry.

Although the present invention has been described and illustrated in respect to exemplary embodiments, it is to be understood that it is not to be so limited, since changes and modifications may be made therein which are within the full intended scope of this invention as hereinafter claimed.

What is claimed is:

1. A pressure monitoring system for aseptic fluid pressure measurement, comprising:
a port communicating with a fluid cavity;
a flexible barrier sealing the port, wherein the barrier is integrally bonded to the port; and
a pressure gauge coupled to the port over the barrier.

2. The system of claim 1, wherein the pressure measuring port is coupled to a fluid path, a fluid container, or a fluid filter.

3. The system of claim 1, wherein the pressure gauge is coupled to the port by a clamp that clamps the pressure gauge to the port.

4. The system of claim 1, wherein the barrier comprises a thermoplastic elastomeric material.

5. The system of claim 4, wherein the barrier is welded to the port.

6. The system of claim 5, wherein the port comprises polypropylene.

7. The system of claim 1, wherein the port comprises an annular flange and a top surface, and wherein the flange has a thickness within the range of about 0.04 inches to about 0.075 inches, and wherein the top surface comprises a flat welding area onto which is integrally bonded the barrier by welding.

8. The system of claim 1, wherein the fluid cavity includes a filter.

9. A pressure measuring port for aseptic fluid pressure measurement, comprising:
a housing comprising an internal cavity for transport of a fluid;
a mouth defining an opening communicating with the internal cavity of the housing; and
a thermoplastic elastomeric film welded to the mouth to seal the mouth;
wherein the internal cavity is aseptically sealed by the film from contact with an external pressure gauge.

10. The port of claim 9, wherein the housing comprises polypropylene.

11. The port of claim 9, wherein the housing houses a filter.

12. A method for aseptically measuring a pressure of a fluid, comprising:
providing a housing having a port communicating with a fluid cavity;
integrally bonding a barrier to the port to seal the fluid cavity;
coupling a pressure gauge to the sealed port outside the sealed fluid cavity; and
measuring a pressure of the fluid in the sealed fluid cavity using the pressure gage via the barrier.

13. The method of claim 12, wherein integrally bonding comprises welding the barrier to the port to seal the fluid cavity.

14. The method of claim 13, further comprising sterilizing the housing, the barrier, and the fluid cavity prior to measuring.

15. The method of claim 14, further comprising discarding the housing and the barrier and re-using the pressure gauge to aseptically measure a pressure of a fluid in another fluid cavity.

16. The method of claim 15, wherein the port comprises polypropylene and the barrier comprises a thermoplastic elastomeric material.

17. The method of claim 13, wherein the housing houses a filter.

18. The method of claim 13, wherein the pressure gauge is reusable for aseptically measuring a pressure of a fluid in another fluid cavity.

19. The method of claim 13, wherein the pressure gauge is re-useable for aseptically measuring a pressure of another fluid.

20. The method of claim 13, wherein the pressure gauge is re-useable for ascetically measuring the pressure of a fluid.
